(19) United States
(12) Patent Application Publication
(10) Pub. No.: US 2025/0351061 A1
(43) Pub. Date: Nov. 13, 2025

(54) WIRELESS NETWORK SLICE FEATURE CONTROL BASED ON RADIO SIGNAL LEVELS

(71) Applicant: T-MOBILE INNOVATIONS LLC, Overland Park, KS (US)

(72) Inventors: George Jason Schnellbacher, Leawood, KS (US); Adrian Ionut Singereanu, Sammamish, WA (US)

(21) Appl. No.: 18/659,939

(22) Filed: May 9, 2024

(51) Int. Cl. H04W 48/18; H04B 7/06; H04B 17/309; H04B 17/318

(52) U.S. Cl. CPC H04W 48/18; H04B 7/0632; H04B 17/328; H04B 17/346

(57) ABSTRACT

A data communication system serves a wireless communication device using a wireless network slice. The data communication system determines one or more radio signal levels for the wireless communication device while the wireless network slice is serving the wireless communication device. The data communication system modifies the wireless network slice based on the one or more radio signal levels for the wireless communication device. The data communication system serves a wireless communication device using the modified wireless network slice.

### TECHNICAL BACKGROUND

Wireless communication networks provide wireless data services to wireless communication devices like phones, computers, and other user devices. The wireless data services may include internet-access, data messaging, video conferencing, or some other data communication product. The wireless communication networks comprise wireless access nodes like Wireless Fidelity (WIFI) hotspots, Fifth Generation New Radio (5GNR) cell towers, and satellites in earth orbit. The wireless communication networks further comprise network elements that process network signaling and handle user data like Access and Mobility Management Functions, Session Management Functions (SMFs), User Plane Functions (UPFs), and Unified Data Management (UDMs).

The wireless communication devices detect radio signal levels like Reference Signal Received Power (RSRP) and Signal-to-Noise (SNR). The wireless communication devices transfer the measured radio signal levels to the wireless access nodes for device handover between the wireless access nodes. For example, when a wireless communication device reports that a target access node has a significantly better RSRP than the source access node, the source access node handsover the wireless communication device to the target access node.

Wireless network slices comprise network elements like UPFs and 5GNR cells that are customized for specific user applications and network services. The wireless communication devices can request the specific wireless network slice for their current user application and network service. The wireless communication networks then deliver this network service using the requested wireless network slice. For example, a user display, drone vehicle, or video system may use a low-latency wireless network slice to serve user applications that need low-latency like augmented-reality, vehicle navigation, cloud gaming, or video aggregation.

### TECHNICAL OVERVIEW

Wireless communication devices measure radio signal levels that characterize their wireless data communications and environment. The radio signal levels comprise metrics like RSRP, SNR, Channel Quality Indicator (CQI), power headroom, frequency channel size, and uplink interference. RSRP comprises the amount of downlink reference signal power that is received by the wireless communication device or the amount of uplink reference signal power that is received by the wireless access node. SNR comprises a ratio of the amount of signal strength received by the wireless communication device to the amount of noise and interference received by wireless communication device. CQI indicates the quality of the downlink from the wireless access node to the wireless communication device and is based on SNR and interference. Power headroom comprises the difference between the current transmit power and the power rating of the radio. The frequency channel size comprises the bandwidth of the electromagnetic spectrum that forms the radio channel. The uplink interference indicates the amount of unwanted radio energy in a frequency band resource.

Wireless network slices serve the wireless communication device by using slice features. The slice features comprise items like target bitrate, packet delay target, priority scheduling (including rate controlled scheduling), radio access technology type, wireless access node, radio band, modulation and coding scheme, target error rate, and link adaptation. The target bit rate comprises the amount of data per time period that traverses a wireless link. The packet delay target comprises the time delay that is required to transmit a data packet over a wireless link and is based on distance, signal quality, network usage, network element quality, and the like. Priority scheduling comprises the order in which radio resources are assigned to user devices where higher priority devices are given radio resources before lower priority devices. Rate controlled scheduling is a form of priority scheduling where the data rate and schedule are adjusted to maintain a latency level—especially for low-latency applications. The radio access technology comprises the type of wireless communication that is used by an access network like 5GNR, WIFI, satellite, or some other wireless protocol. A radio band comprises a contiguous portion of the electromagnetic spectrum that is used for wireless communications. A modulation and coding scheme comprises the number of useful bits that are carried by a wireless resource element. The target error rate comprises an allowable amount of errors out of the total amount of errors. The link adaptation comprises matching the modulation, coding, and other signal parameters to the condition of the radio link.

In some examples, a wireless communication device is served using a wireless network slice. One or more radio signal level metrics for the wireless communication device are determined while the wireless communication device is served using the wireless network slice. The wireless network slice configuration is modified based on the one or more radio signal level metrics for the wireless communication device. The wireless communication device is served using the modified wireless network slice.

In some examples, a wireless network slice serves a wireless communication device. A network control system determines one or more radio signal level metrics for the wireless communication device while the wireless network slice serves the wireless communication device. The network control system can select and activate modifies the optimal wireless network slice based on the one or more radio signal level metric for the wireless communication device. The selected wireless network slice serves the wireless communication device.

### DESCRIPTION OF THE DRAWINGS

FIG. 1 illustrates an exemplary data communication system to control wireless network slice features based on radio signal levels.

FIG. 2 illustrates an exemplary operation of the data communication system to control the wireless network slice features based on the radio signal levels.

FIG. 3 illustrates an exemplary operation of the data communication system to control the wireless network slice features based on the radio signal levels.

FIG. 4 illustrates exemplary processing circuitry to control wireless network slice features based on radio signal levels.

FIG. 5 illustrates an exemplary wireless communication network that controls wireless network slice features based on radio signal levels.

FIG. 6 illustrates an exemplary UE in the wireless communication network that controls the wireless network slice features based on the radio signal levels.

FIG. 7 illustrates an exemplary Fifth Generation New Radio (5GNR) access node in the wireless communication network that controls the wireless network slice features based on the radio signal levels.

FIG. 8 illustrates an exemplary Wireless Fidelity (WIFI) access node in the wireless communication network that controls the wireless network slice features based on the radio signal levels.

FIG. 9 illustrates an exemplary satellite access node and ground station in the wireless communication network that controls the wireless network slice features based on the radio signal levels.

FIG. 10 illustrates an exemplary Network Function Virtualization Infrastructure (NFVI) in the wireless communication network that controls the wireless network slice features based on the radio signal levels.

FIG. 11 illustrates an exemplary operation of the wireless communication network that controls the wireless network slice features based on the radio signal levels.

FIG. 12 illustrates an exemplary operation of the wireless communication network that controls the wireless network slice features based on the radio signal levels.

FIG. 13 illustrates an exemplary operation of the wireless communication network that controls the wireless network slice features based on the radio signal levels.

### DETAILED DESCRIPTION

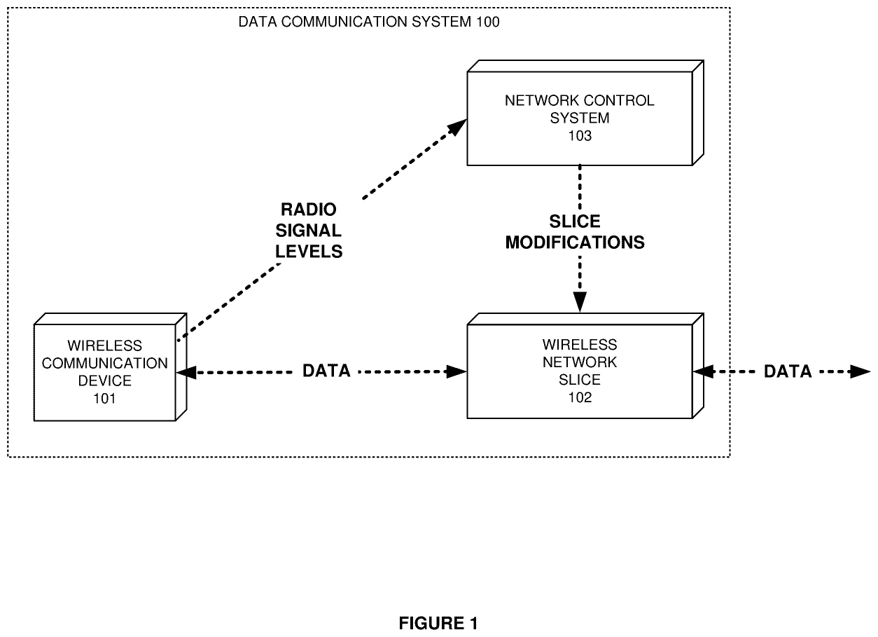

FIG. 1 illustrates exemplary data communication system to control 100 wireless network slice features based on radio signal levels. Data communication system 100 comprises wireless communication device 101, wireless network slice 102, and network control system 103. In some examples, data communication system 100 serves wireless communication device 101 using wireless network slice 102. Network control system 103 determines radio signal levels for wireless communication device 101 while data communication system 100 is serving wireless communication device 101 using wireless network slice 102. Network control system 103 modifies wireless network slice 102 based on the radio signal levels for wireless communication device 101. Data communication system 100 then serves wireless communication device 101 using modified wireless network slice 102.

Subsequent radio signal levels may be determined for wireless communication device 101 while data communication system 100 is serving wireless communication device 101 using modified wireless network slice 102. Network control system 103 may then de-modify wireless network slice 102 based on the subsequent radio signal levels for wireless communication device 101. The de-modification comprises reversing the initial slice modification to revert to the prior version of wireless network slice 102 before the slice modification. Data communication system 100 then serves wireless communication device 101 using de-modified wireless network slice 102.

Wireless communication device 101 comprises a data processor that has components to wirelessly exchange data. Wireless communication device 101 could be a smart-phone, vehicle, sensor, or some other user communication apparatus. Wireless network slice 102 comprises network elements that deliver a low-latency service, high-rate service, or some other wireless communications product. Wireless network slice 102 could include User Plane Functions (UPFs), Access Nodes (ANs), Interworking Functions (IWFs), Session Management Functions (SMF), and/or some other network data apparatus. Network control system 103 comprises network elements that control wireless network slice 102. Network control system 103 could include Access and Mobility Management Functions (AMFs), Unified Data Management (UDMs), wireless ANs, and/or some other network control apparatus.

The radio signal levels for wireless communication device 101 comprise Reference Signal Received Power (RSRP), Signal-to-Noice Ratio (SNR), Channel Quality Indicator (CQI), power headroom, frequency channel size, uplink interference, and/or some other radio metric. The RSRP could be for the uplink or the downlink. RSRP comprises the amount of downlink reference signal power that is received by wireless communication device 101 or the amount of uplink reference signal power that is received by a wireless access node. SNR comprises a ratio of the amount of signal strength received by wireless communication device 101 to the amount of noise and interference received by wireless communication device 101. The term SNR includes Signal-to-Interference and Noise Ratio (SINR). The CQI indicates the quality of the downlink from the wireless access node to the wireless communication device and is based on SNR and interference. Power headroom comprises the difference between the current transmit power of the radio in the device and the maximum power rating of the radio in the device. The frequency channel size comprises the bandwidth of the electromagnetic spectrum that forms the radio channel. The uplink interference indicates the amount of unwanted radio energy in a frequency band resource.

In some examples, wireless network slice 102 serves wireless communication device 101 by using one or more slice configured features that network control system 103 modifies based on the radio signal levels. Such features can apply various techniques to improve items like target bit rate, packet delay target, priority scheduling (including rate controlled scheduling), or to influence changes in radio access technology type, wireless access node, radio band, modulation and coding scheme, target, error rate, link adaptation, and/or some other feature. The target bit rate comprises the amount of data per time period like megabytes per second that traverse a wireless link. The packet delay target comprises the time delay that is required to transmit a data packet over a wireless kink and is based on distance, signal quality, network usage, network element quality, and the like. Priority scheduling comprises the order in which radio resources are assigned where higher priority devices are given radio resources like resource blocks before lower priority devices. Rate/delay controlled scheduling is a form of priority scheduling where the scheduling priority is adjusted to maintain a data rate/packet delay—and can be useful especially for maintaining a data rate or for low-latency applications. The radio access technology comprises the type of wireless communication that is used by an access network like 5GNR, WIFI, satellite, or some other wireless protocol. A radio band comprises a contiguous portion of the electromagnetic spectrum that is used for wireless communications. A modulation and coding scheme comprises the number of useful and error correction bits that are used for transmitting by a wireless resource element. The target error rate comprises an allowable amount of errors (no correction required) out of the total amount of errors. The link adaptation comprises matching the modulation, coding, and other signal parameters to the condition of the radio link.

Wireless communication device 101 and wireless network slice 102 may wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications. Wireless communication device 101, wireless network slice 102, and network control system 103 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

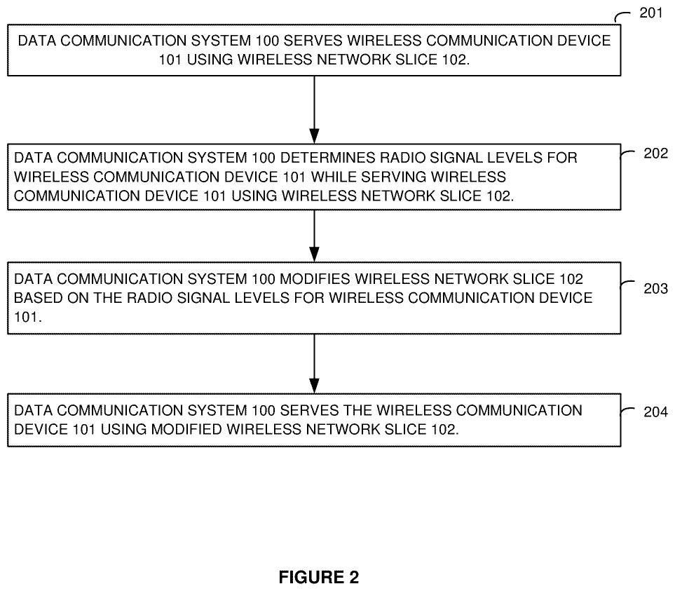

FIG. 2 illustrates an exemplary operation of data communication system 100 to control the wireless network slice features based on the radio signal levels. The operation may differ in other examples. Data communication system 100 serves wireless communication device 101 using wireless network slice 102 (201). Data communication system 100 determines one or more radio signal levels for wireless communication device 101 while serving wireless communication device 101 using wireless network slice 102 (202). Data communication system 100 modifies wireless network slice 102 based on the radio signal levels for wireless communication device 101 (203). Data communication system 100 serves the wireless communication device using the modified wireless network slice 102 (204).

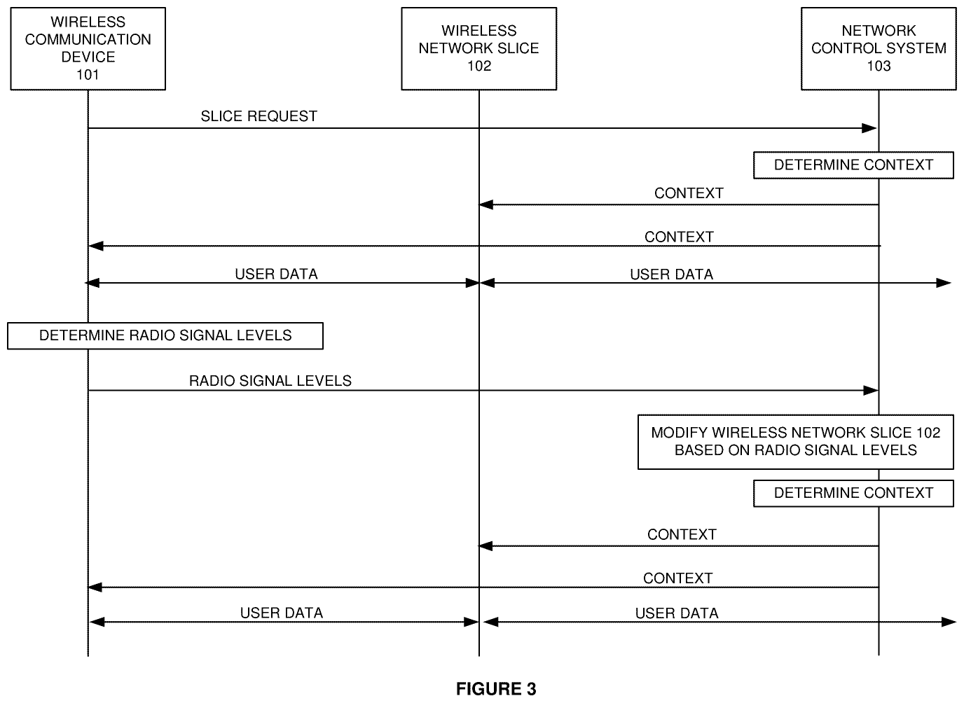

FIG. 3 illustrates an exemplary operation of data communication system 100 to control the wireless network slice features based on the radio signal levels. The operation may differ in other examples. Wireless communication device 101 transfers a slice request for wireless network slice 102 to network control system 103—possibly in response to the launch of a user application. Network control system 103 determines context for the use of wireless network slice 102 by wireless communication device 101. The context indicates network addresses, quality-of-service, slice modification rules, and the like. Network control system 103 transfers some of the context to wireless network slice 102. Network control system 103 also transfers some of the context to wireless communication device 101. In response to the context, wireless communication device 101 exchanges user data with external systems (not shown) over wireless network slice 102. For example, wireless communication device 101 may exchange video data and annotations with an augmented reality server over wireless network slice 102 which delivers low-latency communications.

Wireless communication device 101 measures radio signal levels like RSRP and SNR during its use of wireless network slice 102. Wireless communication device 101 reports the radio signal levels to network control system 103. Network control system 100 applies the slice modification rules to modify wireless network slice 102 for wireless communication device 101 based on the radio signal levels for the wireless communication device 101.

Network control system 103 determines additional context for the use of modified wireless network slice 102 by wireless communication device 101. The additional context may indicate network addresses, quality-of-service, feature modifications, and the like. Network control system 103 transfers some of the additional context—including the feature modifications—to wireless network slice 102. Network control system 103 also transfers some of the additional context to wireless communication device 101. In response to the additional context, wireless communication device 101 exchanges user data with external systems (not shown) over modified wireless network slice 102. For example, wireless communication device 101 may exchange additional video data and annotations with another augmented reality server over modified wireless network slice 102 which now delivers standard-latency communications.

Advantageously, data communication system 100 efficiently and effectively modifies wireless network slice 102 based on the radio signal levels. The slice modifications may improve service to wireless communication device 101 by tailoring slice features to the quality of the radio environment. In addition, the slice modifications may conserve radio resources for other devices by avoiding resource over-consumption by wireless communication device 101.

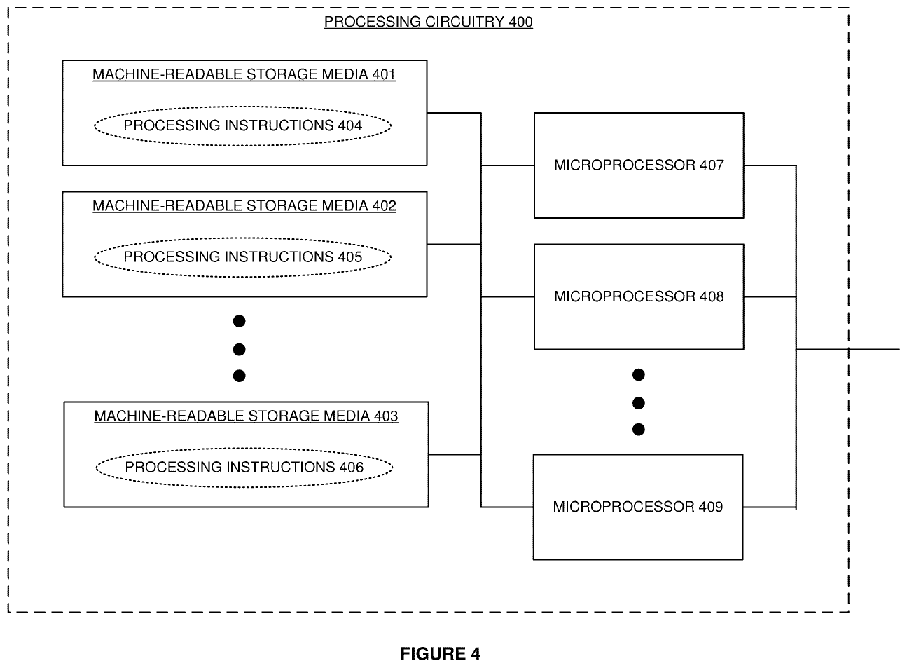

FIG. 4 illustrates exemplary processing circuitry 400 to control wireless network slice features based on radio signal levels. Processing circuitry 400 comprises an example of wireless communication device 101, wireless network slice 102, and network control system 103, although device 101, slice 102, and system 103 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to modify the features of wireless network slices based on radio signal levels as described above for data communication system 100 and as described below for wireless communication network 500. The amount of storage media, microprocessors, processing instructions that are shown in FIG. 4 may vary in other examples.

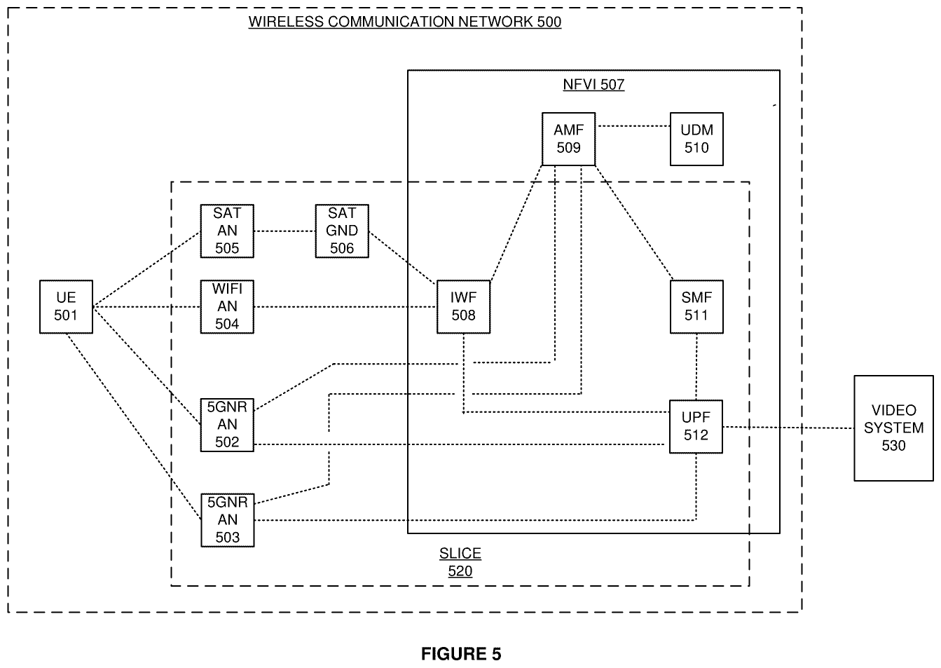

FIG. 5 illustrates an exemplary wireless communication network 500 that controls wireless network slice features based on radio signal levels. Wireless communication network 500 comprises an example of data communication system 100 and processing circuitry 400, although system 100 and circuitry 400 may differ. Wireless communication system 500 comprises User Equipment (UE) 501, Fifth Generation New Radio (5GNR) Access Nodes (ANs) 502-503, Wireless Fidelity (WIFI) AN 504, satellite AN 505, satellite (SAT) Ground Station (GND) 506, and Network Function Virtualization Infrastructure (NFVI) 507. NFVI 507 comprises Interworking Function (IWF) 508, Access and Mobility Management Function (AMF) 509, Unified Data Management (UDM) 510, Session Management Function (SMF) 511, and User Plane Function (UPF) 512. In this example, wireless network slice 520 comprises ANs 502-505, satellite GND 506, IWF 508, SMF 511, and User Plane Function (UPF) 512. Wireless network slice 520 may differ in other examples.

UDM 510 hosts slice modification rules for wireless network slice 520. The slice modification rules indicates how radio signal levels for UE 501 should be processed to determine if wireless network slice 520 should be modified. The radio signal levels comprise RSRP, SNR, CQI, power headroom, frequency channel size, uplink interference, or some other radio signal metric. For example, a slice modification rule may direct 5GNR AN 502 to compare a downlink RSRP level measured by UE 501 to an RSRP threshold to determine if wireless network slice 520 should use rate-controlled scheduling or not. In another example, the slice modification rule may direct 5GNR AN 502 to compare a SNR level measured by UE 501 to a SNR threshold to determine if wireless network slice 520 should use a different radio access technology, frequency band, or access node.

In operation, UE 501 executes an uplink video streaming application that will use wireless network slice 520. In response, UE 501 requests wireless network slice 520 from AMF 509 over 5GNR AN 502. AMF 509 retrieves subscriber information for UE 501 from UDM 510. The information includes an authorization for UE 501 to use slice 520 and includes the slice modification rules for slice 520. AMF 509 and SMF 511 interact to develop context for UE 501 to use wireless network slice 520 like network addresses, quality-of-service levels, and the slice modification rules. SMF 511 transfers some of the context to UPF 512. AMF 509 transfers some of the context to 5GNR AN 502—including the slice modification rules. AMF 509 transfers some of the context to UE 501 over 5GNR AN 502. In response to the context, UE 501 streams video data to video system 530 over 5GNR AN 502 and UPF 512 in slice 520.

UE 501 measures one or more radio signal levels like RSRP and/or SNR. UE 501 reports the radio signal levels to 5GNR AN 502. 5GNR AN 502 applies the slice modification rules for wireless network slice 520 based on the radio signal levels. When a given slice modification rule triggers a slice modification, 5GNR AN 502 performs the slice modification and/or signals AMF 509 to implement the slice modification. AMF 509 may perform the slice modification and/or signal SMF 511 or IWF 508 to implement the slice modification. SMF 511 may perform the slice modification and/or signal UPF 512 to implement the slice modification. AMF 509 signals UE 501 to indicate the slice modification.

For example, 5GNR AN 502 may modify slice 520 by changing the data latency for UE 501 based on the SNR for UE 501. In response to this slice modification, 5GNR AN 502 changes its data latency for UE 501. 5GNR AN 502 also signals AMF 509 to change the data latency for UE 501. In response to the slice modification, AMF 509 signals SMF 511 to change the data latency for UE 501, and SMF 511 signals UPF 512 to change its data latency for UE 501. UPF 512 uses the changed data latency for UE 501. In a like manner, ANs 503-505 and AMF 508 may modify slice 520 based on radio signal levels by changing priority scheduling (including rate-controlled scheduling), modulation and coding scheme, target error rate, link adaptation, wireless target bit rate, or some other context for UE 501.

In another example, 5GNR AN 502 may modify slice 520 by changing the radio access technology for UE 501 based on the RSRP for UE 501 and the received signal power from the new radio access technology (WIFI AN 504 or satellite AN 505). 5GNR AN 502 signals AMF 509 to change the radio access technology for UE 501. AMF 509 signals UE 501 over 5GNR AN 502 to change the radio access technology for slice 520 to WIFI AN 504 or satellite AN 505. AMF 509 signals IWF 508 to serve UE 501 over the new radio access technology for slice 520. AMF 509 signals SMF 511 to serve UE 501 over IWF 508, and SMF 511 signals UPF 512 to serve UE 501 over IWF 508. UPF 512 serves UE 501 over IWF 508 to implement the new radio access technology for slice 520. In a like manner, ANs 502-505 and AMF 508 may modify slice 520 based on radio signal levels by changing radio access technologies, ANs, and/or radio bands.

ANs 503-505 and AMF 508 may modify slice 520 back to its initial features based on the radio signal levels. For example, slice 520 may be initially modified based on an initial SNR level to stop using rate-controlled scheduling, but later, slice 520 may be modified based on a subsequent SNR level to start using rate-controlled scheduling again. Before changing slice 520, a hysteresis time delay may be used to allow the radio signal levels to settle and avoid the rapid back and forth modification of slice 520 due to rapidly changing radio signal levels.

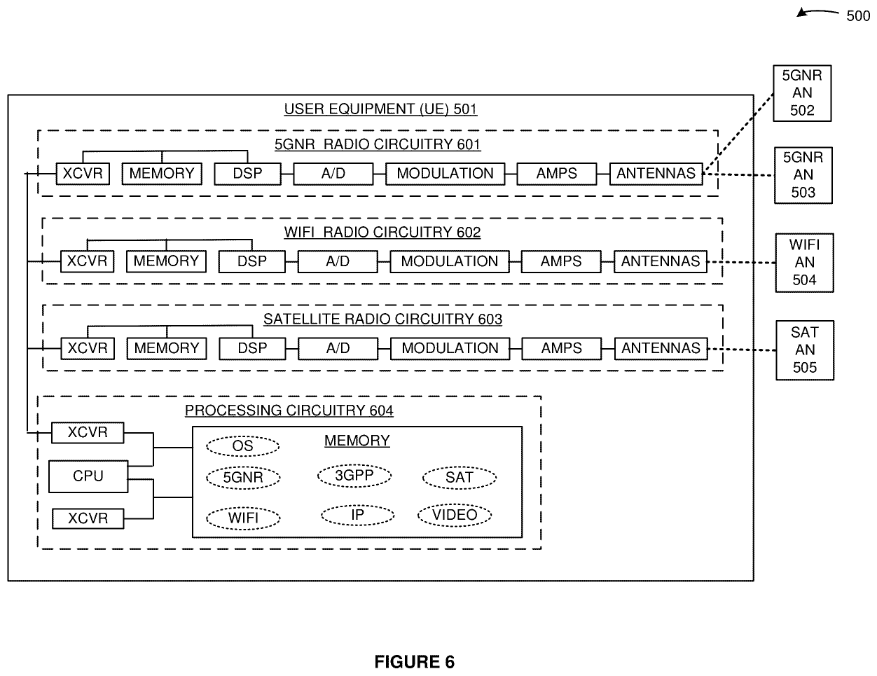

FIG. 6 illustrates exemplary UE 501 in wireless communication network 500 that controls the features of wireless network slice 520 based on the radio signal levels. UE 501 comprises an example of wireless communication device 101 and processing circuitry 400, although device 101 and circuitry 400 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), Internet Protocol application (IP), and Uplink Video application (VIDEO). The antennas in radio circuitry 601-603 exchange wireless signals with ANs 502-505. Transceivers in radio circuitry 601-603 are coupled to transceivers in processing circuitry 604. In processing circuitry 604, the one or more CPUs retrieve the software from the one or more memories and execute the software to direct the operation of UE 501 as described herein. In particular, the PHY measures radio signal levels, and the RRC transfers the radio signal levels to ANs 502-505 as described herein.

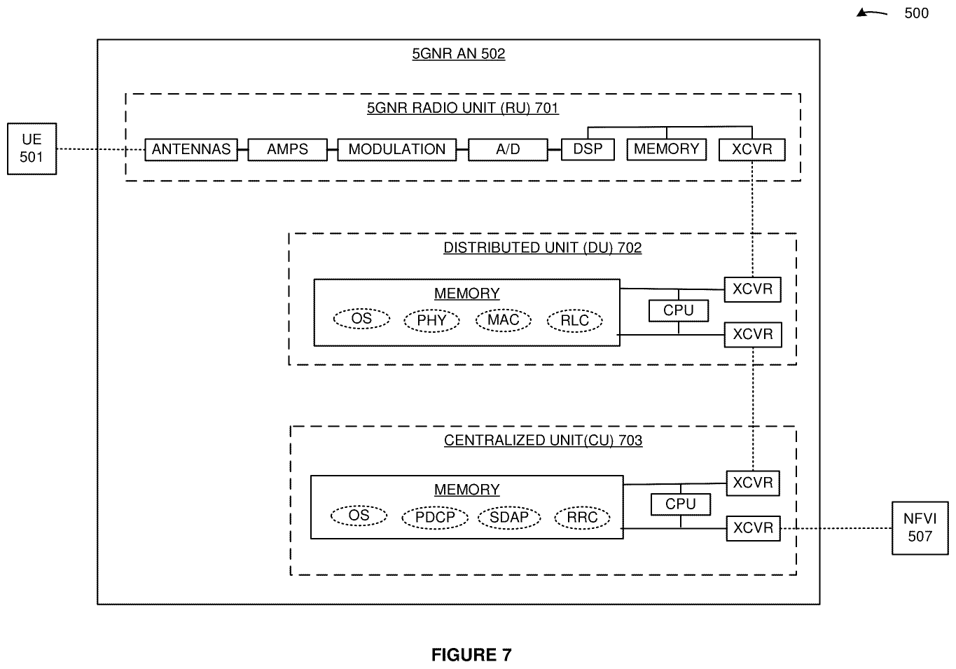

FIG. 7 illustrates exemplary 5GNR AN 502 in wireless communication network 500 that controls the features of wireless network slice 520 based on the radio signal levels. 5GNR AN 502 comprises an example of wireless network slice 102, network control system 103, and processing circuitry 400, although slice 102, system 103, and circuitry 400 may differ. 5GNR AN 503 is typically similar to 5GNR 502 but could differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 507. The DSP and CPU in RU 701, DU 702, and CU 703 execute the radio applications, operating systems, and network applications to exchange data and signaling between UE 501 and NFVI 507 as described herein. In particular, the RRC applies the slice modification rules to the radio signal levels from UE 501 and implements and/or signals any slice modifications as described herein. For example, the MAC may enable/disable rate-controlled scheduling in response to slice modifications.

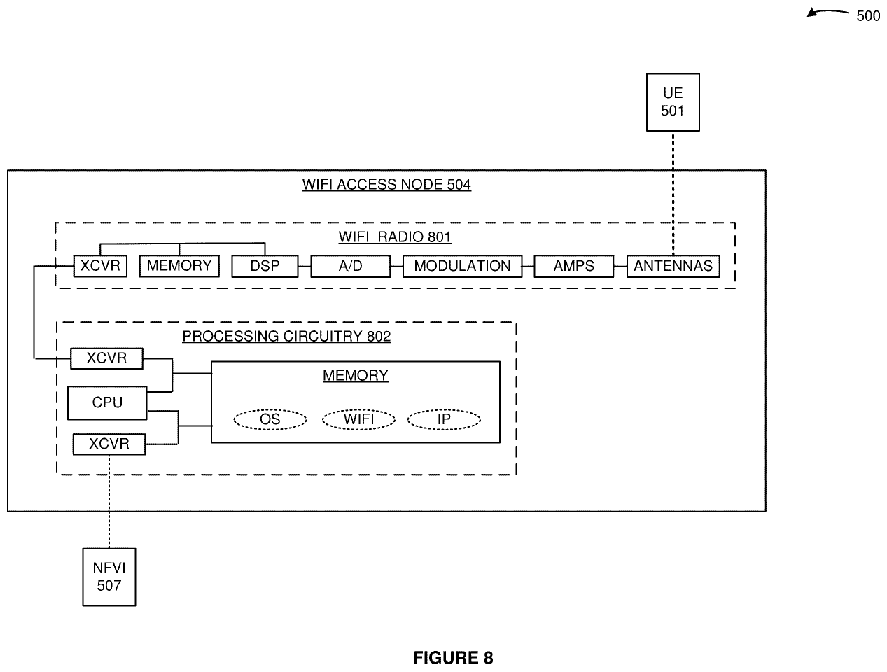

FIG. 8 illustrates exemplary WIFI AN 504 in wireless communication network 500 that controls the features of wireless network slice 520 based on the radio signal levels. WIFI AN 504 comprises an example of wireless network slice 102, network control system 103, and processing circuitry 400, although slice 102, system 103, and circuitry 400 may differ. WIFI AN 504 comprises WIFI radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in NFVI 507. In processing circuitry 802, the one or more CPUs retrieve the software from the one or more memories and execute the software to exchange data and signaling between UE 501 and NFVI 507 as described herein. In particular, the WIFI software may apply slice modification rules and implement slice modifications as described herein.

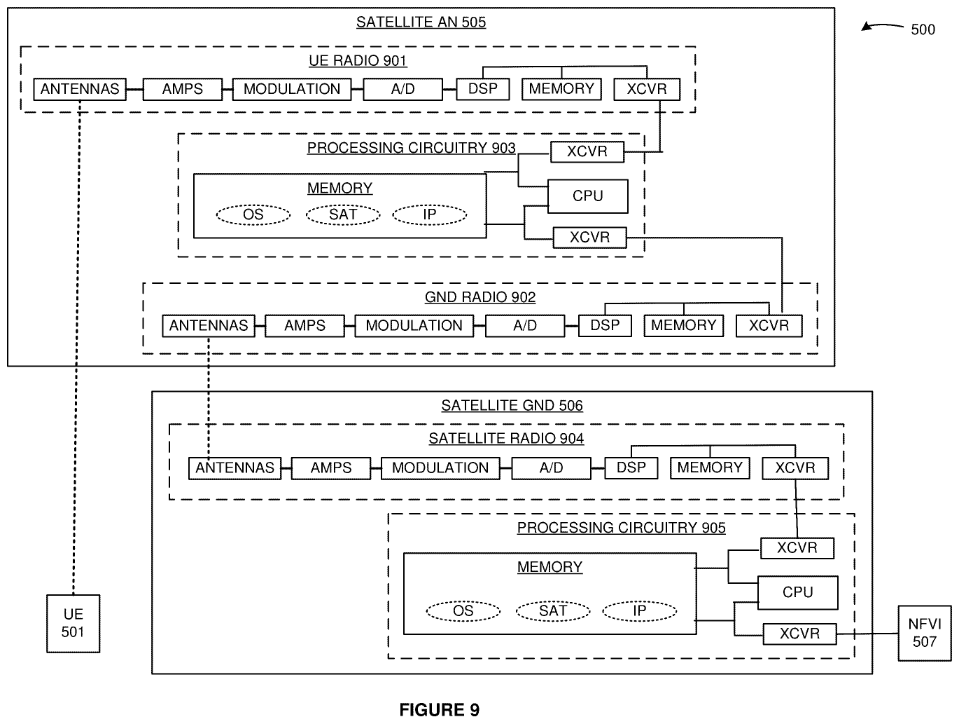

FIG. 9 illustrates exemplary satellite AN 505 and satellite GND 506 in wireless communication network 500 that controls features of wireless network slice 520 based on the radio signal levels. Satellite AN 505 and satellite GND 506 comprise examples of wireless network slice 102, network control system 103, and processing circuitry 400, although slice 102, system 103, and circuitry 400 may differ. Satellite AN 505 comprises UE radio 901, GND radio 902 and processing circuitry 903. Satellite GND 506 comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UE 501. Transceivers in UE radio 901 are coupled to transceivers in processing circuitry 903. Transceivers in processing circuitry 903 are coupled to transceivers in GND radio 902. The antennas in GND radio 902 exchange satellite signals with antennas in satellite radio 904, and the antennas in satellite radio 904 exchange the satellite signals with GND radio 902. Transceivers in satellite radio 904 are coupled to transceivers in processing circuitry 905. Transceivers in processing circuitry 905 are coupled to transceivers in NFVI 507. In processing circuitry 903 and 905, the one or more CPUs retrieve the software from the one or more memories and execute the software to exchange data and signaling between UE 501 and NFVI 507 as described herein. In particular, the SAT software in AN 505 and/or GND 506 may apply slice modification rules to implement slice modifications as described herein.

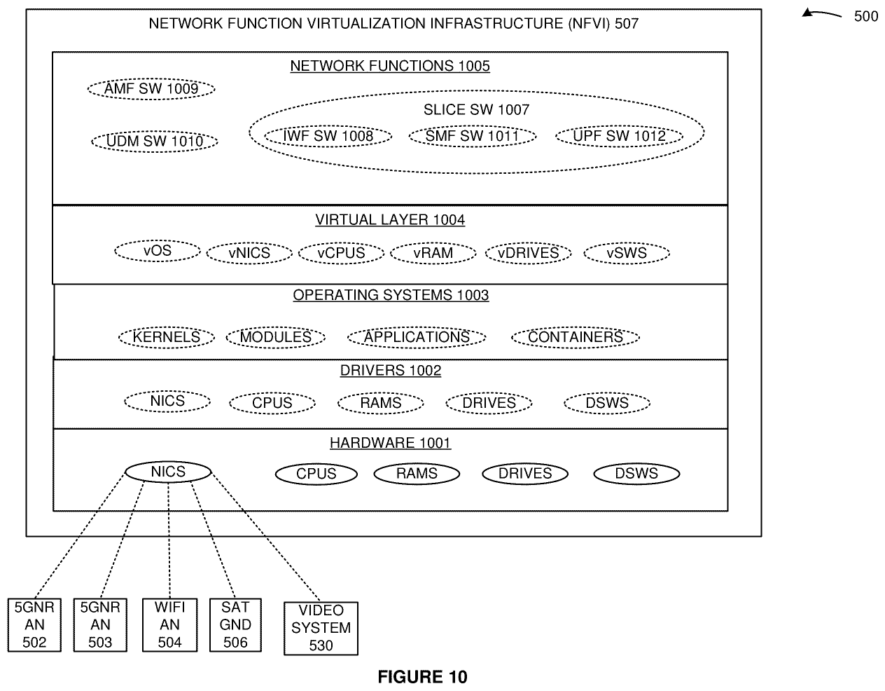

FIG. 10 illustrates exemplary NFVI 507 in wireless communication network 500 that controls the features of wireless network slice 520 based on radio signal levels. NFVI 507 comprises an example of wireless network slice 102, network control system 103, and processing circuitry 400, although slice 102, system 103, and circuitry 400 may differ. NFVI 507 comprises hardware 1001, hardware drivers 1002, operating systems 1003, virtual layer 1004, and network functions 1005. Hardware 1001 comprises Network Interface Cards (NICS), CPUS, RAM, Flash/Disk Drives (DRIVES), and Data Switches (DSWS). Hardware drivers 1002 comprise software that is resident in the NICS, CPUS, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises slice software (SW) 1007, AMF SW 1009, and UDM SW 1010. Slice SW 1007 comprises IWF SW 1008, SMF SW 1011, and UPF SW 1012. The NICS in hardware 1001 are coupled to ANs 502-504, satellite GND 506, and video system 530. Hardware 1001 executes hardware drivers 1002, operating systems 1003, virtual layer 1004, and network functions 1005 to form and operate IWF 509, AMF 510, UDM 511, SMF 511, and UPF 512 as described herein. NFVI 507 comprises one or more microprocessors and one or more non-transitory machine-readable storage media that store processing instructions that direct NFVI 507 to exchange data and signaling between ANs 502-504, satellite GND 505, and video system 530 as described herein. NFVI 507 may be located at a single site or be distributed across multiple geographic locations. In particular, UDM SW 1010 may serve slice modification rules for wireless network slice 520 as described herein. AMF SW 1009 may serve and implement slice modification rules for wireless network slice 520 as described herein. Slice SW 1007 may implement slice modifications for wireless network slice 520 as described herein.

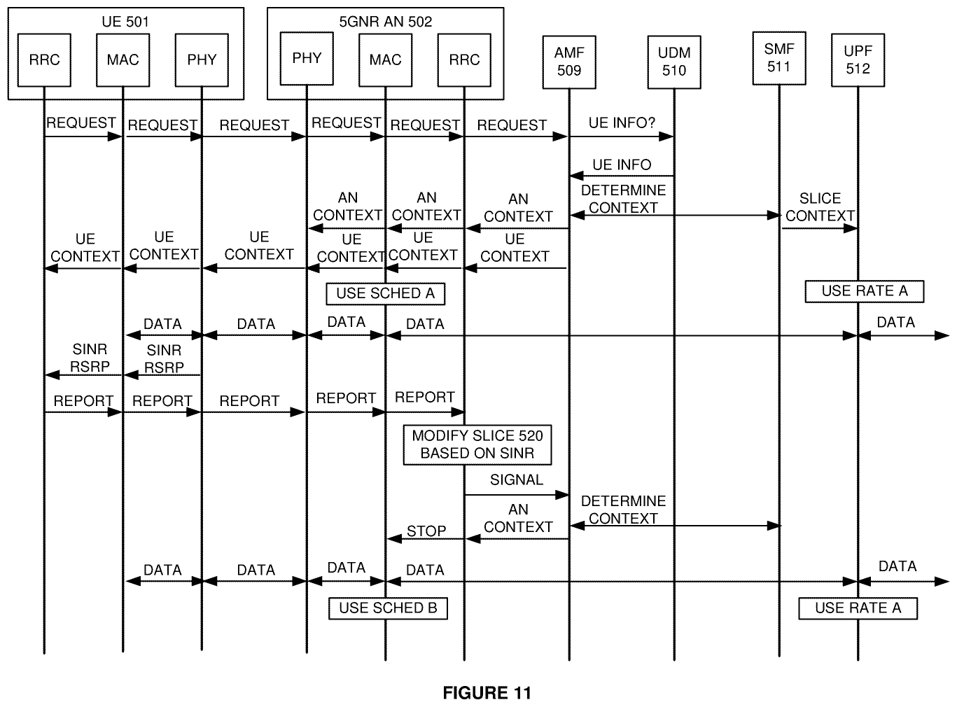

FIG. 11 illustrates an exemplary operation of wireless communication network 500 to control the features of wireless network slice 520 based on the radio signal levels. The operation may differ in other examples. In this example, UE 501 executes an uplink video streaming application that receives rate-controlled scheduling and a high uplink target bit rate from 5GNR AN 502 and UPF 512 based on SNR and RSRP. In response to the launch of the uplink video streaming application, the RRC in UE 501 requests wireless network slice 520 from AMF 509 over the MAC, PHY, and 5GNR AN 502. AMF 509 retrieves subscriber information for UE 501 from UDM 510. The subscriber information includes an authorization for UE 501 to use slice 520. The subscriber information also includes a slice modification rule for the rate-controlled scheduling based on SNR and a slice modification rule for the uplink bit rate based on RSRP. AMF 509 and SMF 511 interact to determine context for UE 501 to use wireless network slice 520. The context comprises network addresses, quality-of-service levels, slice modification rules, and the like. SMF 511 transfers the slice context to UPF 512 which includes the high target bit rate. AMF 509 transfers the AN context to the RRC in 5GNR AN 502 which includes the use of rate-controlled scheduling and the slice modification rules. The RRC in 5GNR AN 502 transfers the pertinent AN context to the MAC and PHY. AMF 509 transfers the UE context to UE 501 over 5GNR AN 502. In response to this context, UE 501 exchanges video and control data with video system 530 (not shown) over 5GNR AN 502 and UPF 512. In particular, the MAC in 5GNR AN 502 uses rate-controlled scheduling (SCHED A) for the video uplink, and UPF 512 uses the high target bit rate (RATE A) for the video uplink.

In UE 501, the PHY measures SNR and RSRP and indicates the SNR and RSRP to the RRC over the MAC. The RRC in UE 501 reports the SNR and RSRP to the RRC in 5GNR AN 502 over the MAC and PHY layers. The RRC in 5GNR AN 502 applies the slice modification rules for the rate-controlled scheduling and the uplink target bit rate. In this example, the SNR reaches or falls below the SNR threshold for using the rate-controlled scheduling, so the RRC signals the slice modification to stop rate controlled scheduling to AMF 509.

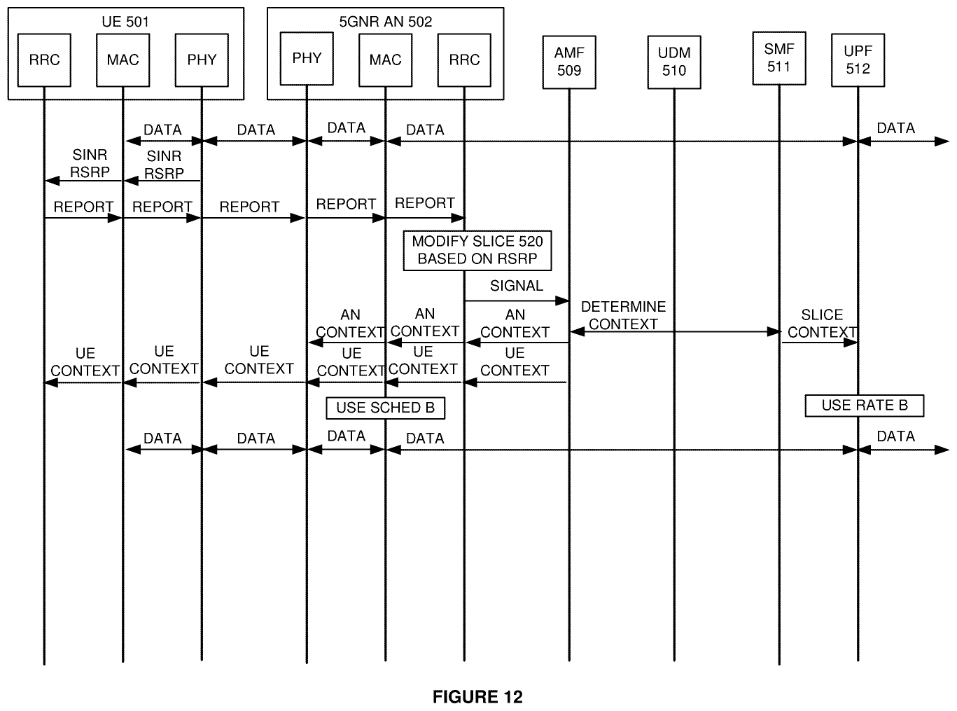

AMF 509 and SMF 511 interact to determine new context for UE 501 to use wireless network slice 520 without rate-controlled scheduling. AMF 509 transfers the AN context to the RRC in 5GNR AN 502 which directs the MAC to stop using rate-controlled scheduling and revert to regular scheduling. UE 501 still exchanges video and control data with video system 500 over its MAC and PHY, 5GNR AN 502, and UPF 512. UPF 512 still uses the high uplink target bit rate (RATE A) for the video uplink. However, the MAC in 5GNR AN 502 now uses regular scheduling (SCHED B) for the video uplink. The operation continues on FIG. 12.

FIG. 12 illustrates an exemplary operation of wireless communication network 500 to control the features of wireless network slice 520 based on the radio signal levels. The operation may differ in other examples. The operation continues from FIG. 11. UE 501 exchanges video and control data with video system 500 (not shown) over its MAC and PHY, 5GNR AN 502, and UPF 512. In UE 501, the PHY measures SNR and RSRP and indicates the SNR and RSRP to the RRC over the MAC. The RRC in UE 501 reports the SNR and RSRP to the RRC in 5GNR AN 502 over the MAC and PHY layers. The RRC in 5GNR AN 502 applies the slice modification rules for the rate-controlled scheduling and the uplink target bit rate. In this example, the RSRP reaches or falls below the RSRP threshold for using the high uplink target bit rate, so the RRC signals the slice modification to lower the uplink target bit rate to AMF 509.

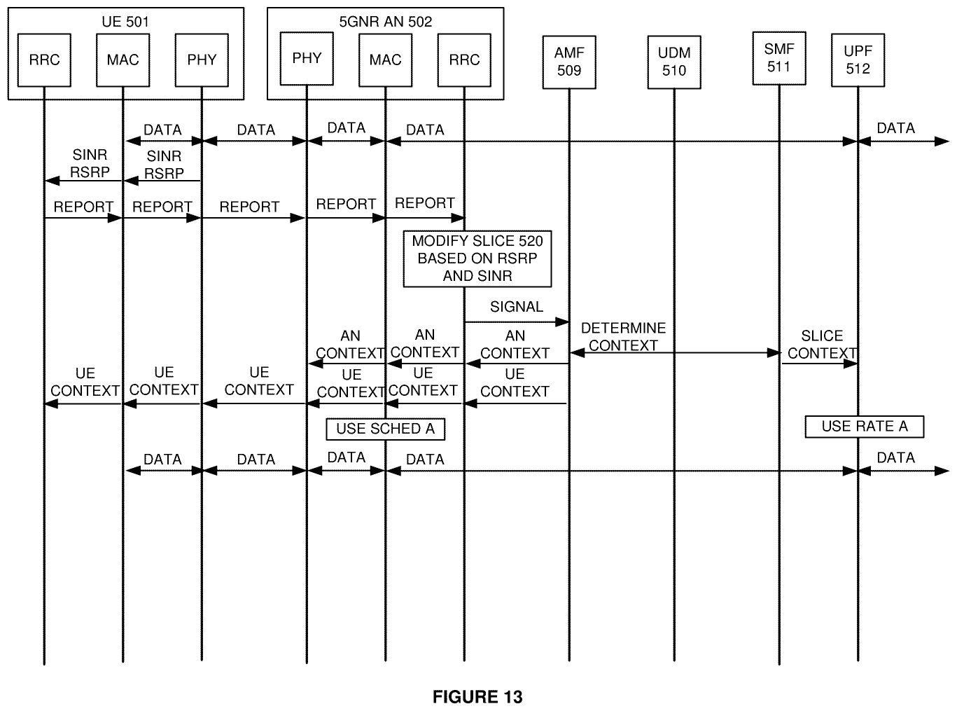

AMF 509 and SMF 511 interact to determine new context for UE 501 to use wireless network slice 520 with a lower uplink target bit rate. SMF 511 transfers the slice context to UPF 512 which includes the lower uplink target bit rate. AMF 509 transfers the AN context to the RRC in 5GNR AN 502 which includes the lower uplink target bit rate. The RRC in 5GNR AN 502 directs its MAC and PHY to use the lower uplink target bit rate. AMF 509 transfers the UE context to the RRC in UE 501 over 5GNR AN 502 which includes the lower uplink target bit rate. The RRC in UE 501 directs its MAC and PHY to use the lower uplink target bit rate. In response to this new context, UE 501 exchanges video and control data with a video system 530 over 5GNR AN 502 and UPF 512. In particular, the PHYs, MACs, and UPF 512 use the lower uplink target bit rate (RATE B) for the video uplink. The operation continues on FIG. 13.

FIG. 13 illustrates an exemplary operation of wireless communication network 500 to control the features of wireless network slice 520 based on the radio signal levels. The operation may differ in other examples. The operation continues from FIG. 12. UE 501 exchanges video and control data with video system 530 (not shown) over its MAC and PHY, 5GNR AN 502, and UPF 512. In UE 501, the PHY measures SNR and RSRP and indicates the SNR and RSRP to the RRC over the MAC. The RRC in UE 501 reports the SNR and RSRP to the RRC in 5GNR AN 502 over the MAC and PHY layers. The RRC in 5GNR AN 502 applies the slice modification rules for the rate-controlled scheduling and the uplink target bit rate. In this example, the RSRP now reaches or exceeds the RSRP threshold for using the high uplink target bit rate. In addition, the SNR now reaches or exceeds the SNR threshold for using the rate-controlled scheduling. The RRC signals in 5GNR AN 502 signals the slice modifications to raise the uplink target bit rate and to use rate-controlled scheduling to AMF 509.

AMF 509 and SMF 511 interact to determine new context for UE 501 to use wireless network slice 520 with the high uplink target bit rate and rate controlled scheduling. SMF 511 transfers the slice context to UPF 512 which includes the high uplink target bit rate. AMF 509 transfers the AN context to the RRC in 5GNR AN 502 which includes the high uplink target bit rate and the rate controlled scheduling. The RRC in 5GNR AN 502 directs its MAC and PHY to use the high uplink target bit rate and rate controlled scheduling. AMF 509 transfers the UE context to the RRC in UE 501 over 5GNR AN 502 which includes the high uplink target bit rate. The RRC in UE 501 directs its MAC and PHY to use the high uplink target bit rate. In response to this latest context, UE 501 exchanges video and control data with video system 530 over 5GNR AN 502 and UPF 512. In particular, the PHYs, MACs, and UPF 512 use the high uplink target bit rate (RATE A) for the video uplink. The MAC in 5GNR AN 502 uses rate-controlled scheduling (SCHED A) for the video uplink.

Advantageously, wireless communication network 500 efficiently and effectively modifies wireless network slice 520 based on the radio signal levels. The slice modifications improve service to UE 501 by tailoring slice features to the quality of the radio environment. In addition, the slice modifications conserve radio resources for other UEs by avoiding resource over-consumption by UE 501.

The wireless communication system circuitry described above comprises computer hardware and software that form special-purpose data communication circuitry to modify wireless network slices based on radio signal levels. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry system to modify wireless network slices based on radio signal levels.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
serving a wireless communication device using a wireless network slice;
determining one or more radio signal levels for the wireless communication device while serving the wireless communication device using the wireless network slice;
modifying the wireless network slice based on the one or more radio signal levels for the wireless communication device; and
serving the wireless communication device using the modified wireless network slice.

2. The method of claim 1 wherein:
determining the one or more radio signal levels for the wireless communication device comprises determining downlink Reference Signal Received Power (RSRP) for the wireless communication device; and
modifying the wireless network slice based on the one or more radio signal levels for the wireless communication device comprises modifying the wireless network slice based on the downlink RSRP for the wireless communication device.

3. The method of claim 1 wherein:
determining the one or more radio signal levels for the wireless communication device comprises determining uplink Reference Signal Received Power (RSRP) for the wireless communication device; and
modifying the wireless network slice based on the one or more radio signal levels for the wireless communication device comprises modifying the wireless network slice based on the uplink RSRP for the wireless communication device.

4. The method of claim 1 wherein:
determining the one or more radio signal levels for the wireless communication device comprises determining Signal-to-Noice Ratio (SNR) for the wireless communication device; and
modifying the wireless network slice based on the one or more radio signal levels for the wireless communication device comprises modifying the wireless network slice based on the SNR for the wireless communication device.

5. The method of claim 1 wherein:
determining the one or more radio signal levels for the wireless communication device comprises determining frequency channel size for a frequency channel used by the wireless communication device; and
modifying the wireless network slice based on the one or more radio signal levels for the wireless communication device comprises modifying the wireless network slice based on the frequency channel size for the frequency channel used by wireless communication device.

6. The method of claim 1 wherein:
determining the one or more radio signal levels for the wireless communication device comprises determining uplink interference for an access node used by the wireless communication device; and
modifying the wireless network slice based on the one or more radio signal levels for the wireless communication device comprises modifying the wireless network slice based on the uplink interference for the access node used by wireless communication device.

7. The method of claim 1 wherein:
determining the one or more radio signal levels for the wireless communication device comprises determining power headroom for the wireless communication device; and
modifying the wireless network slice based on the one or more radio signal levels for the wireless communication device comprises modifying the wireless network slice based on the power headroom for the wireless communication device.

8. The method of claim 1 wherein:
serving the wireless communication device using the wireless network slice comprises serving the wireless communication device using priority scheduling;
modifying the wireless network slice based on the one or more radio signal levels for the wireless communication device comprises modifying the priority scheduling; and
serving the wireless communication device using the modified wireless network slice comprises serving the wireless communication device using the modified priority scheduling.

9. The method of claim 1 further comprising:
determining one or more subsequent radio signal levels for the wireless communication device while serving the wireless communication device using the modified wireless network slice;
de-modifying the wireless network slice based on the one or more subsequent radio signal levels for the wireless communication device; and
serving the wireless communication device using the de-modified wireless network slice.

10. One or more non-transitory computer readable storage media having program instructions stored thereon, wherein the program instructions, when executed by a computing system, direct the computing system to perform operations, the operations comprising:
serving a wireless communication device using a wireless network slice;
determining one or more radio signal levels for the wireless communication device while serving the wireless communication device using the wireless network slice;
modifying the wireless network slice based on the one or more radio signal levels for the wireless communication device; and
serving the wireless communication device using the modified wireless network slice.

11. The one or more non-transitory computer readable storage media of claim 10 wherein:
serving the wireless communication device using the wireless network slice comprises serving the wireless communication device over a first radio access technology type;
modifying the wireless network slice based on the one or more radio signal levels for the wireless communication device comprises modifying the first radio access technology type to a second radio access technology type based on the one or more radio signal levels for the wireless communication device; and
serving the wireless communication device using the modified wireless network slice comprises serving the wireless communication device over the second radio access technology type.

12. The one or more non-transitory computer readable storage media of claim 10 wherein:
serving the wireless communication device using the wireless network slice comprises serving the wireless communication device over a first radio band;
modifying the wireless network slice based on the one or more radio signal levels for the wireless communication device comprises modifying the first radio band to a second radio band based on the one or more radio signal levels for the wireless communication device; and
serving the wireless communication device using the modified wireless network slice comprises serving the wireless communication device over the second radio band.

13. The one or more non-transitory computer readable storage media of claim 10 wherein:
serving the wireless communication device using the wireless network slice comprises serving the wireless communication device over a first wireless access node;
modifying the wireless network slice based on the one or more radio signal levels for the wireless communication device comprises modifying the first wireless access node to a second wireless access node based on the one or more radio signal levels for the wireless communication device; and
serving the wireless communication device using the modified wireless network slice comprises serving the wireless communication device over the second wireless access node.

14. The one or more non-transitory computer readable storage media of claim 10 wherein:
determining the one or more radio signal levels for the wireless communication device while serving the wireless communication device using the wireless network slice comprises determining Channel Quality Indicator (CQI);
modifying the wireless network slice based on the one or more radio signal levels for the wireless communication device comprises modifying the wireless network slice based on the CQI.

15. The one or more non-transitory computer readable storage media of claim 10 wherein:
serving the wireless communication device using the wireless network slice comprises serving the wireless communication device using a first target error rate;
modifying the wireless network slice based on the one or more radio signal levels for the wireless communication device comprises modifying the first target error rate to a second target error rate based on the one or more radio signal levels for the wireless communication device; and
serving the wireless communication device using the modified wireless network slice comprises serving the wireless communication device over the second target error rate.

16. The one or more non-transitory computer readable storage media of claim 10 wherein:
serving the wireless communication device using the wireless network slice comprises serving the wireless communication device using a first target bit rate;
modifying the wireless network slice based on the one or more radio signal levels for the wireless communication device comprises modifying the first target bit rate to a second target bit rate based on the one or more radio signal levels for the wireless communication device; and
serving the wireless communication device using the modified wireless network slice comprises serving the wireless communication device using the second target bit rate.

17. The one or more non-transitory computer readable storage media of claim 10 wherein:
serving the wireless communication device using the wireless network slice comprises serving the wireless communication device using a first packet delay target;
modifying the wireless network slice based on the one or more radio signal levels for the wireless communication device comprises modifying the first packet delay target to a second packet delay target based on the one or more radio signal levels for the wireless communication device; and
serving the wireless communication device using the modified wireless network slice comprises serving the wireless communication device using the second packet delay target.

18. A data communication system comprising:
a wireless network slice to serve a wireless communication device;
a network control system to determine one or more radio signal levels for the wireless communication device while the wireless network slice is serving the wireless communication device;
a network control system to modify the wireless network slice based on the one or more radio signal levels for the wireless communication device; and
the wireless network slice to serve the wireless communication device based in the modification.

19. The data communication system of claim 18 wherein:
the wireless network slice is to serve the wireless communication device using rate controlled scheduling to serve the wireless communication device;
the network control system is to stop the rate controlled scheduling by the wireless network slice based on the one or more radio signal levels for the wireless communication device to modify the wireless network slice based on the one or more radio signal levels for the wireless communication device; and
the wireless network slice is to serve the wireless communication device without using the rate controlled scheduling to serve the wireless communication device based on the modification.

20. The data communication system of claim 18 wherein:
the network control system is to determine at least one of Reference Signal Received Power (RSRP) and Signal-to-Noise Ratio (SNR) to determine the one or more radio signal levels for the wireless communication device while the wireless network slice is serving the wireless communication device; and
the network control system is to modify the wireless network slice based on the at least one of the RSRP and the SNR to modify the wireless network slice based on the one or more radio signal levels for the wireless communication device.
